(19) United States
(12) Patent Application Publication
(10) Pub. No.: US 2026/0163087 A1
(43) Pub. Date: Jun. 11, 2026

(54) High-Voltage Battery for a Vehicle, and Vehicle

(71) Applicant: Bayerische Motoren Werke Aktiengesellschaft, Muenchen (DE)

(72) Inventor: Robert ALIG, Germering (DE)

(21) Appl. No.: 18/712,039

(22) PCT Filed: Nov. 22, 2022
(86) PCT No.: PCT/EP2022/082786

§ 371 Date: May 21, 2024

(30) Foreign Application Priority Data
Dec. 9, 2021 (DE) 10 2021 132 430.0

(51) Int. Cl. H01M 10/48; B60L 50/64; H01M 50/204; H01M 50/249

(52) U.S. Cl. CPC H01M 10/482; B60L 50/64; H01M 50/204; H01M 50/249; H01M 2220/20

(57) ABSTRACT

A high-voltage battery for a vehicle includes a housing, a plurality of battery cells arranged in the housing and connected to one another, a conductor arranged in the housing outside the battery cells and designed to increase a conductivity of a fluid in the housing outside the battery cells, and at least one detector design to detect the fluid in the housing outside the battery cells.

### BACKGROUND AND SUMMARY

The invention relates to a high-voltage battery for a vehicle. The invention further relates to a vehicle.

Modern vehicles, more particularly electric vehicles and/or hybrid vehicles, have a high-voltage battery in which electrical energy is stored to power the vehicle. Inside the high-voltage battery is arranged a plurality of battery cells and/or blocks of battery cells connected to one another so as to provide a DC voltage of, for example, 400, 600 or 800 volts. Such high-voltage batteries need to meet very high safety criteria.

An object of the invention is to help ensure high safety in a high-voltage battery for a vehicle.

The object is achieved by the features disclosed herein. Advantageous configurations are also characterized in the present disclosure.

The invention has the particular feature of a high-voltage battery for a vehicle. The invention has the further particular feature of a vehicle comprising the high-voltage battery.

The high-voltage battery comprises a housing. The housing comprises for example a bottom part and a lid. The bottom part and/or the lid are made for example of aluminum and/or steel and/or plastic. The bottom part and the lid are sealed, more particularly hermetically sealed, such that they separate, more particularly hermetically separate, an inner region of the housing from an outer region. The bottom part and the lid are for example screwed and/or glued together.

The high-voltage battery further comprises a plurality of battery cells arranged in the housing and connected to one another.

The battery cells are arranged for example in blocks of battery cells that are connected in parallel or in series in order to provide a DC voltage of, for example, 400, 600 or 800 volts.

The high-voltage battery further comprises a conductor that is arranged in the housing outside the battery cells and is designed to increase the conductivity of a fluid in the housing outside the battery cells.

The conductor is more particularly an ion donor, so that it is possible to increase a conductivity of a fluid in the housing outside the battery cells.

The high-voltage battery further comprises at least one detector designed to detect the fluid in the housing outside the battery cells.

The at least one detector comprises for example a fill level sensor that is arranged in the housing outside the battery cells and determines, for example by a measurement of electrical resistance, whether a fluid is arranged in the housing outside the battery cells.

Alternatively or in addition, the battery cells may also comprise a detector that determines, for example by measuring the insulation resistance of poles of the battery cells, whether a fluid is present in the housing outside the battery cells.

As described, the housing is in principle sealed. However, in certain circumstances it is possible for fluids to penetrate into the housing. Thus, water may for example penetrate through an emergency opening for a thermal event, such as a pressure relief valve. Alternatively or in addition, water may penetrate through a pressure equalization valve, for example a PTFE (polytetrafluoroethylene) membrane, for example due to condensation. Alternatively or in addition, cooling system conduits of the battery cells and the like may have leaks. In addition, the housing may develop a leak as a result of mechanical damage.

These fluids make it possible for air-gap distances and creepage distances to be electrically bridged. This can result in defective insulation and self-discharge. Rapid self-discharge can in fact result in a thermal event. The apposed high voltage can result in the electrochemical splitting of water. The hydrogen evolved can undergo an exothermic oxyhydrogen reaction. Defective insulation can also result in potential shifts with local chemical reactions (e.g. oxidation). Over time this can lead to further reaction cascades, for example a battery cell develops a leak and a proportion of the lithium released by the battery cell reacts with water, with the formation of hydrogen.

It is therefore important for fluids to be detected swiftly.

Since it is possible for different fluids to get into the high-voltage battery, it is difficult for conductivity sensors to recognize when the fluid level is too high, because the conductivities of different fluids vary greatly. For instance, distilled water, which can penetrate through condensation, has an electrical conductivity of about 10·10⁻⁶ S/m. Ethylene glycol, which can penetrate as a result of a defective cooling conduit that contains antifreeze, has an electrical conductivity of 1.16·10⁻⁴ S/m. Coolants are particularly conductive.

The conductor can help ensure that fluids, more particularly the fluids mentioned above, can be reliably detected by the detector. This can therefore help ensure high safety in the high-voltage battery.

In an optional configuration, the conductor is solid or fluid, in particular gel-like.

For example, the conductor is a conducting salt or an electrolyte gel based on an alkali metal and/or an alkaline earth metal, such as chloride (for example sodium chloride, potassium chloride, calcium chloride, magnesium chloride) and/or sulfate, and/or based on alkali metal hydroxide or alkali metal cyanide and/or based on an oxide, such as iron oxide.

In a further optional configuration, the conductor is arranged in a depot.

In a further optional configuration, the depot is sealed and comprises a mechanical opening for the release of the conductor.

The mechanical opening is opened for example by a pressure or a float switch, by the fluid in the housing outside the battery cells.

As a result, the conductor is arranged in a highly protected manner and will not for example be dissolved by atmospheric moisture.

In a further optional configuration, the depot has a labyrinthine structure.

As a result, the conductor is also arranged in a highly protected manner and will not be immediately dissolved and/or dispersed.

In a further optional configuration, a surfactant is in addition arranged in the housing outside the battery cells.

The surfactant is for example arranged in the same depot as the conductor. Alternatively or in addition, it is arranged in a second depot.

As already described, it is possible for various fluids to penetrate into the housing. These include for example also organic fluids such as heat-transfer oils and/or coolants. The surfactant is able to bind these organic fluids. The surfactant accordingly promotes the dissolution of the conductor in the organic fluid. This results in the organic fluid becoming conductive.

In a further optional configuration, the conductor is arranged in a region within the housing that is the deepest region within the housing when the high-voltage battery has been installed in the vehicle.

More particularly, the depot is arranged in this region.

This can help ensure that the fluid in the housing outside the battery cells mixes swiftly with the conductor.

In a further optional configuration, the conductor is chemically bound by a binder, the binder being designed to release the conductor through contact with fluid.

Working examples of the invention are more particularly elucidated hereinbelow with reference to the schematic drawing.

### BRIEF DESCRIPTION OF THE DRAWINGS

FIG. 1 shows a high-voltage battery for a vehicle.

### DETAILED DESCRIPTION OF THE DRAWINGS

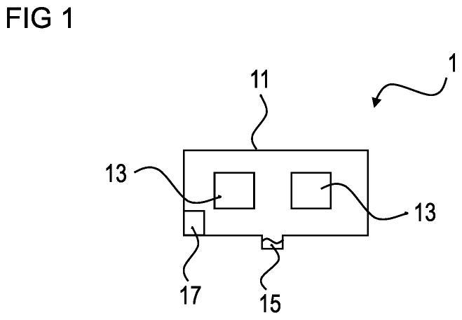

FIG. 1 shows a high-voltage battery 1 for a vehicle comprising a housing 11, a plurality of battery cells 13 arranged in the housing 11 and connected to one another, a conductor 15 that is arranged in the housing 11 outside the battery cells 13 and is designed to increase a conductivity of a fluid in the housing 11 outside the battery cells 13, and one or more detectors 17 that are designed to detect the fluid in the housing 11 outside the battery cells 13.

The conductor 15 is for example fluid, in particular gel-like, as shown in the FIGURE. Alternatively, it is solid. For example the conductor 15 is a conducting salt or an electrolyte gel. For example, the conductor 15 comprises an alkali metal and/or alkaline earth metal and/or a chloride and/or sodium chloride and/or potassium chloride and/or calcium chloride and/or magnesium chloride and/or a sulfate and/or an alkali metal hydroxide and/or an alkali metal cyanide and/or on an oxide and/or an iron oxide.

The conductor 15 is for example arranged in a depot. The depot can, as shown in the FIGURE, be designed in the housing 11, for example in the form of a recess in a bottom section of the housing. Alternatively, it can be a standalone unit arranged in the housing 11.

The depot is, for example, as shown in the FIGURE, arranged in a region within the housing 11 that is the deepest region within the housing 11 when the high-voltage battery 1 has been installed in the vehicle.

The depot can for example have a closing mechanism with a mechanical opening for release of the conductor. The mechanical opening is opened for example by a pressure or a float switch, by the fluid in the housing 11 outside the battery cells 13.

Alternatively or in addition, the depot may have a labyrinthine structure.

The battery cells 13 are more particularly accumulator cells. In the housing 11 is arranged a plurality of battery cells 13, for example a few to thousands of accumulator cells or blocks of accumulator cells, connected to one another in parallel and/or in series. This is able to generate a battery nominal voltage of, for example, 400 to 1000 volts and can be used to power a vehicle.

The housing 11 comprises for example a bottom part and a lid. The bottom part is produced for example by a thermoforming process. The bottom part and/or the lid are made for example of aluminum and/or steel and/or plastic. The bottom part and the lid are sealed, more particularly hermetically sealed, such that they separate, more particularly hermetically separate, an inner region of the housing from an outer region. The bottom part and the lid are for example screwed and/or glued together.

Arranged between the bottom part and the lid is, for example, a PTFE membrane.

In the housing 11 are arranged, for example, further elements that are not depicted, such as cooling hoses, cooling units, connections for power and/or cooling, pressure relief valves, and similar.

Also arranged in the housing 11, as shown in the FIGURE, is at least one detector 17, for example a fill level sensor that is arranged in the housing 11 outside the battery cells 13 and determines, for example by a measurement of electrical resistance, whether a fluid is arranged in the housing 11 outside the battery cells 13.

For example, the fill level sensor is arranged beneath the battery cells 13 when the housing 11 has been installed.

Alternatively or in addition, the battery cells 13 may also comprise a detector 17 that determines, for example by measuring the insulation resistance of poles of the battery cells 13, whether a fluid is present in the housing 11 outside the battery cells 13.

In addition, a surfactant may be arranged in the housing 11 outside the battery cells 13. The surfactant is for example arranged in the same depot as the conductor 15. Alternatively or in addition, it is arranged in a second depot.

When the vehicle is in operation, fluids may penetrate into the housing. Thus, water may for example penetrate through an emergency opening for a thermal event, such as a pressure relief valve. Alternatively or in addition, water may penetrate through a pressure equalization valve, for example the PTFE membrane, for example due to condensation. Alternatively or in addition, conduits of a cooling system of the battery cells 13 and the like may have leaks.

These fluids make it possible for air-gap distances and creepage distances to be electrically bridged. This can result in defective insulation and self-discharge. Rapid self-discharge can in fact result in a thermal event. The apposed high voltage can result in the electrochemical splitting of water. The hydrogen evolved can undergo an exothermic oxyhydrogen reaction. Defective insulation can also result in potential shifts with local chemical reactions (e.g. oxidation). Over time this can lead to further reaction cascades, for example a battery cell develops a leak and a proportion of the lithium released by the battery cell reacts with water, with the formation of hydrogen.

Since it is possible for different fluids to get into the high-voltage battery 1, it is difficult for conductivity sensors to recognize when the fluid level is too high, because the conductivities of different fluids vary greatly. For instance, distilled water, which can penetrate through condensation, has an electrical conductivity of about 10·10⁻⁶ S/m. Ethylene glycol, which can penetrate as a result of a defective cooling conduit that contains antifreeze, has an electrical conductivity of 1.16·10⁻⁴ S/m. Coolants are particularly conductive.

The conductor 15 can help ensure that fluids, more particularly the fluids mentioned above, can be reliably detected by the detector 17. This can therefore help ensure high safety in the high-voltage battery 1.

1-9. (canceled)

10. A high-voltage battery for a vehicle comprising:
a housing;
a plurality of battery cells arranged in the housing and connected to one another;
a conductor that is arranged in the housing outside the battery cells and is configured to increase a conductivity of a fluid in the housing outside the battery cells; and
at least one detector configured to detect the fluid in the housing outside the battery cells.

11. The high-voltage battery according to claim 10, wherein the conductor is solid.

12. The high-voltage battery according to claim 10, wherein the conductor is fluid.

13. The high-voltage battery according to claim 10, wherein the conductor is arranged in a depot.

14. The high-voltage battery according to claim 13, wherein the depot is sealed and comprises a mechanical opening configured to release the conductor.

15. The high-voltage battery according to claim 13, wherein the depot has a labyrinthine structure.

16. The high-voltage battery according to claim 10, comprising:
a surfactant arranged in the housing outside the battery cells.

17. The high-voltage battery according to claim 10,
wherein the conductor is arranged in a region within the housing that is a deepest region within the housing when the high-voltage battery has been installed in the vehicle.

18. The high-voltage battery according to claim 10,
wherein the conductor is chemically bound by a binder, the binder configured to release the conductor through contact with fluid.

19. A vehicle comprising:
the high-voltage battery according to claim 10.
